(19) United States
(12) Patent Application Publication
(10) Pub. No.: US 2015/0066867 A1
(43) Pub. Date: Mar. 5, 2015

(54) SYSTEMS AND METHODS FOR ZERO-KNOWLEDGE ATTESTATION VALIDATION

(71) Applicant: eweware, inc., Santa Monica, CA (US)

(72) Inventors: David Vronay, Santa Monica, CA (US); Ruben Kleiman, Redwood City, CA (US)

(21) Appl. No.: 14/455,783

(22) Filed: Aug. 8, 2014

Related U.S. Application Data
(60) Provisional application No. 61/870,752, filed on Aug. 27, 2013.

(51) Int. Cl. H04L 29/08; G06F 17/30

(52) U.S. Cl. CPC H04L 67/1097; G06F 17/30194
USPC 707/687

(57) ABSTRACT

The method for zero-knowledge attestation validation process includes receiving a statement from a primary account in a primary electronic database over a communication network for validation with an authority account in an authority electronic database, creating a set of keys permitting validation of the statement without the primary electronic database identifying the authority account and without the authority electronic database identifying the primary account, associating a first key with the statement, correlating the associated first key and statement with a second key identifying the authority account, validating the veracity of the statement as an attestation with the authority account over the communication network, relating the first key to the attestation, linking the related first key and attestation with a third key identifying the primary account, and transmitting the attestation to the primary electronic database over the communication network for storage in the primary account with the statement.

### BACKGROUND OF THE INVENTION

The present invention relates to systems and methods for zero-knowledge attestation validation. More specifically, the present invention relates to systems for validating user statements in a primary system with other information stored in an authority system without disclosing the unique identity of the user in the authority system to the primary system or the unique identity of the user in the primary system to the authority system.

Joining an online membership network or community typically requires users to create a unique identity that allows the system to recognize the user for purposes of personal interaction within the system. Such systems may include social media networks, discussion forums, corporate directories, games, virtual worlds, etc. Typically, users access their unique identity in each respective system by entering an account username and password. This unique identity may be specific to a particular system, network, or community, and not necessarily shared. For example, a social media network may allow users to create an identity (i.e., a profile) to befriend other identities (i.e., other users) and share messages, comments, pictures, and other content. The system, network, or community gains knowledge through analyzing user behavior and interaction. This knowledge can then be used to make attestations about user behavior. For example, a social media network may learn, inter alia, the behavior of a user interacting with games, apps or friends within the construct of the online platform. The social media network may be able to attest, for example, that two particular users are or are not friends.

Users typically belong to or are otherwise members of multiple systems, networks, communities, etc. For instance, one user may be a member of an online technology discussion forum and an employee of a technology company, and may have different identities in each system. For example, the user may be identified by username in the online discussion forum and may be identified by corporate email address with human resources at the technology corporation. As such, each system may be able to make different attestations about the user. Here, the online discussion forum may be able to attest that the user has made a certain number of posts or has a certain number of followers, while the corporation may be able to attest that the user is employed with the corporation or that the user is in a management position.

The user may want to make a claim or statement in one system (i.e., the “primary system”) that only another system (i.e., the “authority system”) can attest. For example, the aforementioned technology discussion forum member may want to provide extra credence to forum comments by providing profile identification information that includes the fact that the user is a senior level manager of a technology company. The problem is that the discussion forum cannot attest to workplace credentials; only the technology corporation can attest to those credentials. Several methods of verifying a statement in a system that cannot attest to the veracity thereof are known in the art; however, each method has limitations and drawbacks.

For example, the system may allow users to make certain statements or claims that are otherwise not verified by any authority. Here, the system may allow users to input current employer, age, city of residence, or other personal information into a user profile without actually validating or verifying the information. In fact, the information in the profile is subject to the care and honesty of each user and may be incorrect for variety of reasons, including mistake (e.g., typographical error), accident (e.g., forgetting to update information), or intentional deceit (e.g., a lie).

Another issue is that known systems have no good or efficient way of ferreting out false information. For example, a retail store owner might post a negative review about a competitor in an online review forum falsely claiming a negative shopping experience with the competitor as a way of steering customers away from the competitor. Since this claim is unverified, there is no way of knowing if the review is legitimate or false. Some systems attempt to rectify this deficiency by allowing other users to vote or comment on the veracity of the reviews or statements made by other users. This approach can reduce problems associated with false or misinformation, but such comments do not eliminate the false statements altogether and some false statements may be difficult, if not impossible, to identify. If a false review is not immediately recognizable, other users may not readily vote the review down, if at all. As a result, it may appear on its face that the false review is, in fact, genuine. Of course, unknowing consumers may rely on the review and, in the above example, steer clear of the above-mentioned competitor. In this example, the false review still accomplishes its goal of diverting business. This type of system also allows users to collude in voting on content. For example, several users may vote up a negative review of a competitor. The colluding users may also use botnets employing thousands of fake accounts to falsely vote on statements. Importantly, botnets and other false account schemes may be difficult to detect and may be expensive to ameliorate.

Another method requires that users provide the primary system with unique authority system identity information, and then allow the primary system to essentially impersonate the user to access the authority system. In this situation, the primary system may gain access to all information in the authority system during the authentication process. In the context of the example mentioned above, this method may require the technology discussion forum member to provide a corporate email address and password to the forum system so the forum can directly log in to the corporation to verify the member's employment status. This method is designed to prevent the propagation of false information (e.g., representations the member is employed by the technology company) while also enhancing the credibility of the users to the system. Unfortunately, this approach creates numerous other issues.

First, the user must trust the primary system with the authority system identity. Many users have security concerns providing a primary system with an authority system identity that permits access to sensitive information (e.g., financial, medical, or other personal or private information). Unscrupulous primary systems may sell the identity information to advertisers or other third parties—this may occur with or without the consent or knowledge of the user. Moreover, even if trustworthy at first, the primary system may change its terms of use to permit the sale or distribution of the private information, or new owners with different motivations and levels of respect for personal information may take control. Additionally, the breach of trust may not be directly under the control of the primary system. For example, the primary system might be compromised by hackers or compelled to release information by a governmental entity.

Second, users may want to share the authority system identity with the primary system only to make one specific attestation, without realizing that act implicitly grants permission to other information or for other attestations. For example, a social media network user might grant permission for a friend to see a photo without realizing that friend now has permission to see other content posted on the network. Some systems attempt to ameliorate this problem by providing users with elaborate permission management schemes, many of which are complex, difficult if not impossible to completely understand and are, therefore, prone to error. Additionally, such permissions schemes place the onus on the user by unreasonably requiring an intimate understanding of the trust relationships the user has with other entities and statements on the system.

Third, it is difficult to revoke permission to the authority system identity once the user initially grants the permission. That is, once information is released, it is difficult or impossible to reliably reclaim. This issue is further compounded in circumstances where the user wants to revoke the permissions of a primary system that is no longer trustworthy. The now untrustworthy primary system has no incentive to properly dispose of the user authority system identity and may continue to use the authority system identity in an unauthorized manner. While merely an inconvenience in social networks or discussion forums, the aforementioned security issues may prevent such a method from being employed in systems containing sensitive information (e.g., medical or financial records) due to the risk of serious financial loss or legal action.

There exists, therefore, a significant need in the art for systems and methods for zero-knowledge attestation validation that permit an authority system to make an attestation about a user in a primary system without disclosing the authority system identity to the primary system, and without disclosing the primary system identity to the authority system. The present invention fulfills these needs and provides further related advantages.

### SUMMARY OF THE INVENTION

The systems and methods for zero-knowledge attestation validation as disclosed herein includes, in one embodiment, steps for receiving a statement from a primary account in a primary electronic database over a communication network for validation with an authority account in an authority electronic database. Here, a set of keys are created to permit validation of the statement without the primary electronic database identifying the authority account and without the authority electronic database identifying the primary account. In this respect, a first key is associated with the statement and then the two are matched with a second key having identification information related to the authority account. The system is able to validate the veracity of the statement as an attestation with the authority account over the communication network by cross-referencing the information in the statement with information in the authority account. This information may be true if the system can reliably cross-reference the information in the statement with the authority account, or the information may be false if the system is unable to match or cross-reference the information. The next step is for the system to relate the attestation with the first key and then link the two with a third key identifying the primary account. This enables the system to transmit the attestation to the primary electronic database over the communication network for storage in the primary account with the statement. At this point, the statement may be considered verified or validated as being true or false.

Preferably, the second key is deleted after the relating step, the first key is deleted after the linking step, and the third key is deleted after the transmitting step to enhance the security of the system. Although, deleting the keys in the sequence described above is not necessary because none of the keys have both the authority and primary account or system identity information at any given time. Each of the set of keys may also be encrypted to enhance security, but, again, encryption is not necessary for the reasons mentioned above.

Preferably, the correlating step further includes the step of matching the first key with the second key so the system can find the authority electronic database and the authority account for purposes of conducting the validating step. Similarly, the linking step preferably includes matching the first key with the third key so the system can find the primary electronic database and the primary account after the unattested statement has been validated. To further enhance security, the associating step preferably associates the first key with the statement outside the primary electronic database and the relating step preferably relates the first key with the attestation outside the authority electronic database. The statement initially includes an unverified statement that may be true or false. The validation step is designed to cross-reference the veracity of the statement such that the statement itself can be transformed during the transmitting step from an unverified statement to a verified statement (i.e., certified as true or false).

In other aspects of the above-mentioned method, the associating step may include forming a badge request from the associated first key and the statement and the relating step may include forming a badge from the first key and the attestation. The transfer of information in accordance with the methods disclosed herein is preferably conducted over a communication network, which may further facilitate steps that include sending the badge request to a badge creator, conveying the attestation to the badge creator, sending the badge to a badge servicer, and/or conveying the second key to a third party for identifying the authority account. The user statement may also include multiple statements and the set of keys may include multiple sets of keys, whereby each set of keys corresponds to a respective statement. In this embodiment, the system may generate more than one attestation to correspond with the veracity of each statement. The primary electronic database may include a social network and the authority electronic database may include a corporate network, and the first key may include a correlation key, the second key may include a retrieval key and the third key may include a verification key.

In another embodiment, a method for zero-knowledge attestation validation may include steps for receiving a statement from a primary account in a primary electronic database over a communication network for validation with an authority account in an authority electronic database. In response, the system may create a set of keys permitting validation of the statement without the primary electronic database accessing the authority account and without the authority electronic database accessing the primary account. This is accomplished by issuing a badge request that includes a first key and the statement. Next, the badge request is correlated with a second key identifying the authority account. The first and second keys are matched to each other so the badge request can be transmitted to the authority account for purposes of validating the statement. Accordingly, the system then validates the veracity of the statement as an attestation with the authority account over the communication network. Next, a badge is formed from the information associated with the first key and the attestation and linked to the third key identifying the primary account. In the linking step, the system matches information from the first key with information in the third key. The attestation is then transmitted to the primary electronic database over the communication network for storage in the primary account with the statement and the first, second and third keys are deleted to ensure security.

Further with respect to this embodiment, the issuing step preferably includes issuing the badge request outside the primary electronic database and the forming step preferably includes forming the badge outside the authority electronic database, to enhance the security of the system. The transmitting step may also transform an unverified statement to a verified statement. Of course, the verified statement may be recognized as being a true statement or a false statement, depending on whether the information in the statement was successfully cross-referenced with the authority account. Additionally, the communication network may facilitate sending the badge request to the badge creator, sending the badge to the badge servicer, conveying the attestation to the badge creator, and communicating the second key to a third party for identifying the authority account. Although, the third key is preferably stored with the badge servicer after creation and until the transmitting step. Lastly, the statement may include multiple statements and the set of keys may include multiple sets of keys, wherein each set of keys corresponds to a respective statement and the primary electronic database may include a social network and the authority electronic database may include a corporate network.

In another embodiment of a method for zero knowledge attestation validation, the system may produce at least three matchable keys and convey a first key to a third party having information on an authority account and convey a second key associated with an unverified statement to a badge creator. The third key is preferably retained with a badge servicer. Next, the system matches the first key having the authority account with the second key having the unverified statement in the badge creator. An attestation can be created based on the veracity of the unverified statement through cross-reference with information in the authority account. The created attestation is then correlated with the second key and matched with the third key in the badge servicer. Here, the attestation can be stored in association with a primary account associated with the unverified statement. Accordingly, the system can transform the unverified statement into a verified statement based on comparing the attestation with the unverified statement without the authority account identifying the primary account and without the primary account identifying the authority account.

In a preferred embodiment, the correlating step includes forming a badge that includes the second key and the attestation. Additionally, the first key may be deleted after the creating step and the badge request may be created using the second key and the unverified statement. The system may further send the badge request to the authority account to validate the veracity of the unverified statement with the authority account. Of course, the verified statement could include a true or false statement depending on the success of the cross-reference with the authority account.

In another alternative embodiment, a method for zero-knowledge attestation validation includes communicating with an authority account in a first electronic database over a communication network to attest to the veracity of at least one unattested statement made in a second electronic database associated with a primary account, creating at least one badge attesting to the veracity of the at least one unattested statement, conveying the at least one badge to the second electronic database over the communication network, storing the at least one badge in association with the primary account in the second electronic database and transforming the at least one unattested statement into at least one attested statement without the authority account in the first electronic database identifying the primary account in the second electronic database and without the primary account in the second electronic database identifying the authority account in the first electronic database.

In this embodiment, the communicating step preferably includes requesting at least one badge from a badge creator and the badge request preferably includes forming a badge retrieval key, a badge correlation key, and a badge verification key. The badge retrieval key may be presented to the badge creator such that the badge retrieval key can be matched with the badge correlation key. Similarly, the at least one badge may be presented to the badge servicer and then matched with the badge verification key. This method may also include the step of conveying the badge retrieval key to a third party and the badge correlation key to the badge creator, and storing the badge verification key with the badge servicer.

Other features and advantages of the present invention will become apparent from the following more detailed description, when taken in conjunction with the accompanying drawings, which illustrate, by way of example, the principles of the invention.

### BRIEF DESCRIPTION OF THE DRAWINGS

The accompanying drawings illustrate the invention. In such drawings:

FIG. 1 is a diagrammatic view illustrating a preferred embodiment wherein the systems and methods disclosed herein provide zero-knowledge attestation validation;

FIG. 2 is a flowchart illustrating one method for providing zero-knowledge attestation validation in accordance with the embodiments disclosed herein;

FIG. 3 is a flow chart illustrating a method for creating a set of validation keys with a badge servicer;

FIG. 4 is a diagrammatic view illustrating one embodiment for distributing the set of validation keys within the system;

FIG. 5 is a diagrammatic view illustrating relative arrangement of the set of validation keys after distribution thereof;

FIG. 6 is a diagrammatic view illustrating one embodiment for presenting a badge retrieval key to a badge creator;

FIG. 7 is a diagrammatic view illustrating one embodiment for sending a badge request from the badge creator to an authority system;

FIG. 8 is a flow chart illustrating a method for verifying the veracity of information stored in the badge request;

FIG. 9 is a diagrammatic view illustrating one embodiment for sending an attestation to the badge creator;

FIG. 10 is a flow chart illustrating a method for sending the badge and the attestation to the badge servicer with the badge correlation key;

FIG. 11 is a diagrammatic view illustrating one embodiment for sending the badge to the badge servicer by way of the badge creator;

FIG. 12 is a diagrammatic view illustrating the arrangement of the badge and the set of validation keys after the badge servicer stores the badge with the badge verification key;

FIG. 13 is a diagrammatic view illustrating the system after the badge has been stored with the primary system identity of the user; and

FIG. 14 is a diagrammatic view illustrating a communication system for use in connection with the zero-knowledge attestation validation methods disclosed herein.

### DETAILED DESCRIPTION OF THE PREFERRED EMBODIMENTS

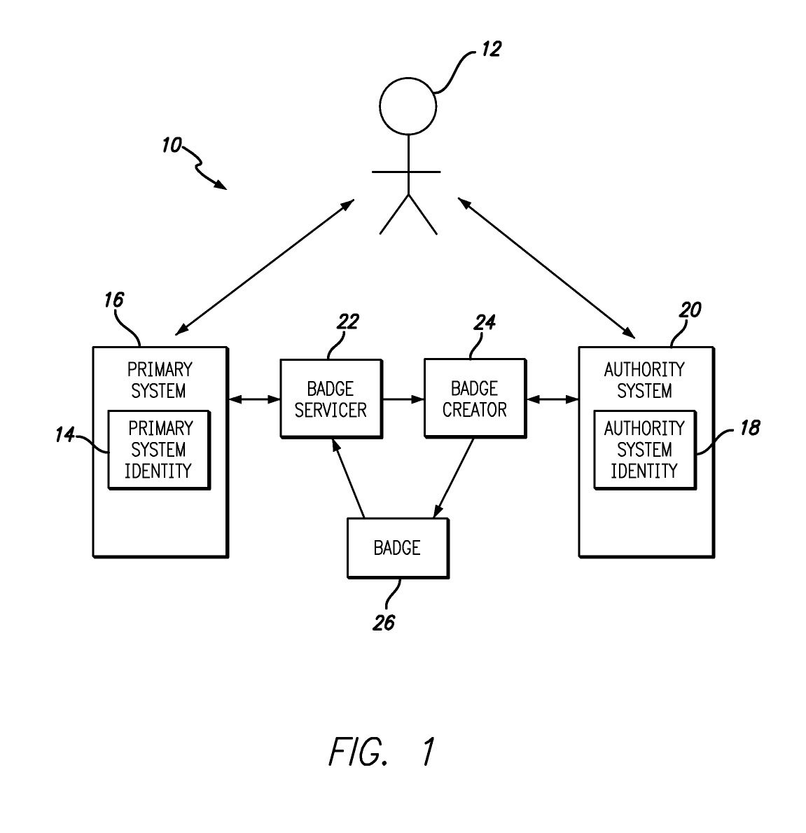

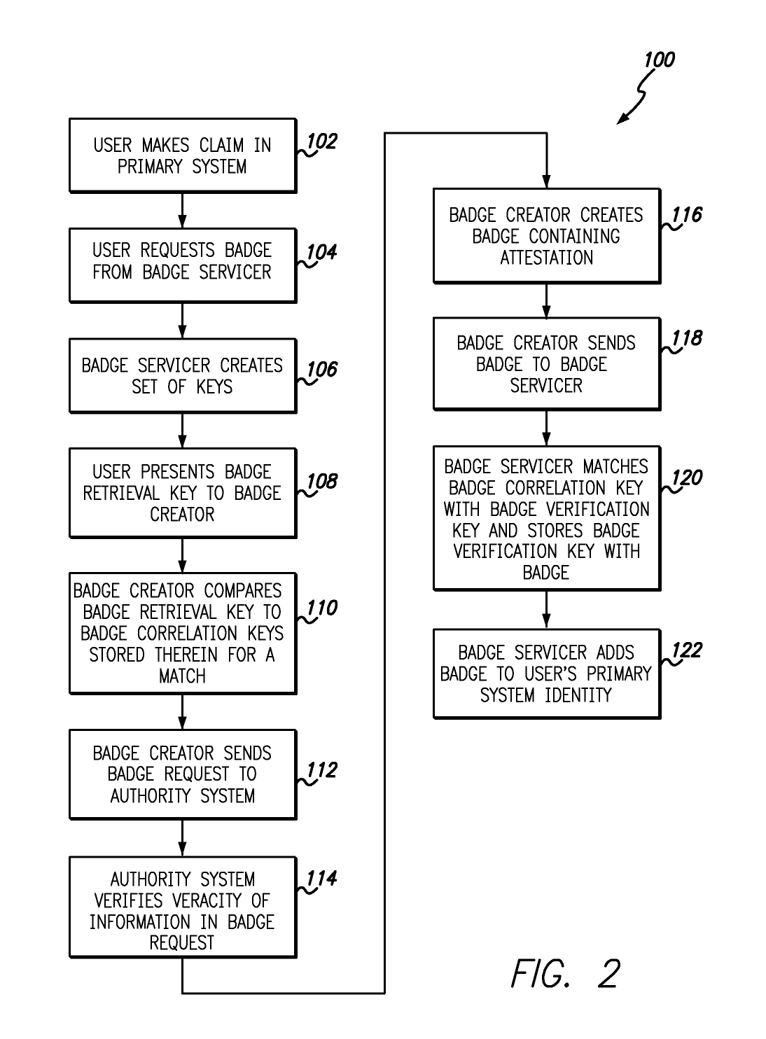

As shown in the drawings for purposes of illustration, the present invention for a system for zero-knowledge attestation validation is generally shown by reference numeral 10 in FIG. 1, and the related systems and methods are shown more specifically in the flowcharts, schematics and diagrams of FIGS. 2-14. In general, as illustrated in FIG. 1, the zero-knowledge attestation system 10 includes a user 12 with a primary system identity 14 accessible through a primary system 16 and an authority system identity 18 accessible through an authority system 20. The user 12 may be an individual, a machine (e.g., a computer program, online service, or any other machine capable of interacting with the primary system 12), or some combination thereof. The primary and authority system identities 14, 18 may be a unique token such as a user account, username, profile, social security number, apartment or house number, phone number, email address, or virtually any other type of information that uniquely identifies a user and allows interaction through the primary and authority systems 16, 20, respectively. Alternately, the identities 14, 18 may include a plurality of non-unique tokens (e.g., a username and an address), the combination of which is unique to the user 12. The primary and authority systems 16, 20 may be social media networks, corporate directories, virtual worlds, games, discussion forums, or other types of systems through which the user 12 can interact using the primary and/or the authority system identities 14, 18, respectively.

Importantly, the authority system 20 is the only source of information to verify the veracity of a statement or claim made by the user 12 in the primary system 16. As discussed in greater detail below, the system 10 allows the authority system 20 to attest to the veracity of a claim or statement made by the user 12 or that will be made by the user 12 in the primary system 16 without the primary system 16 learning the authority system identity 18 or the authority system 20 learning the primary system identity 14. The primary and authority systems 16, 20 may be different types of systems (e.g., one is a social media network and the other is a corporate directory) or the same type of system (e.g., both are social media networks). For example, if a social media network user claims thereon to be employed by Corporation X, the system 10 allows the social media network (i.e., the primary system 16) to use the employee directory of Corporation X (i.e., the authority system 20) to verify that the social media user is in fact an employee of Corporation X. In this regard, the corporate directory can attest to the veracity of the social media user's statement on the social media site. Importantly, the system 10 prevents the social media network from learning the identity of the user 12 at Corporation X and prevents Corporation X from knowing the identity of the user 12 on the social media network.

In an alternate embodiment, the primary system 16 and the authority system 20 may be distinct parts of a single larger system. For example, a corporate human resources system may have different levels of access for different levels of the management structure. Specifically, human resources managers may have a high access level, non-management human resources personnel may have an intermediate access level, and garden-variety employees may have a low access level. As such, the system 10 may be able to verify a claim made by an employee with a low access level by using information available only available to those with a high access level, all without disclosing sensitive information between or among the access levels. Thus, the employee with low level access can still obtain validation despite never seeing the sensitive information necessary to validate the statement or claim.

Importantly, the distinction between the primary system 16 and the authority system 20 is not permanent. The primary system 16 in one attestation may in fact be the authority system 20 in a different attestation. For example, a social media network may be the authority system 20 if the user 12 wants to verify on a discussion forum that Bob Smith is a friend of the user 12. These roles are also easily reversible. The discussion forum may become the authority system 20 if the user 12 wants to verify with the social media network a certain number of posts on the discussion forum. The distinction between the primary system 16 and the authority system 20 is relevant only to the specific attestation, i.e., which system is attempting to verify the statement or claim (i.e., the primary system 16) and which system is authenticating the statement or claim (i.e., the authority system 20).

To facilitate zero-knowledge attestation validation, the system 10 further includes a badge servicer 22 associated with the primary system 16 and a badge creator 24 associated with the authority system 20. The badge servicer 22 requests one or more badges 26 from the badge creator 24 in response to the user 12 asserting or intending to assert a claim or statement on the primary system 16. The badge creator 24 communicates with the authority system 20 to determine the veracity of the statements or claims made by the user 12, then creates one or more badges 26 representing this veracity or lack thereof (i.e., attestation) in response to the request for the same by the badge servicer 22. The badge servicer 22 and the badge creator 24 are preferably distinct components separate from the primary system 16 and the authority system 20, respectively, thereby permitting anonymous and secure communication between the primary and authority systems 16, 20. Alternately, the badge servicer 22 and the badge creator 24 may be integrated into the primary system 16 and/or the authority system 20, respectively, in lower security systems.

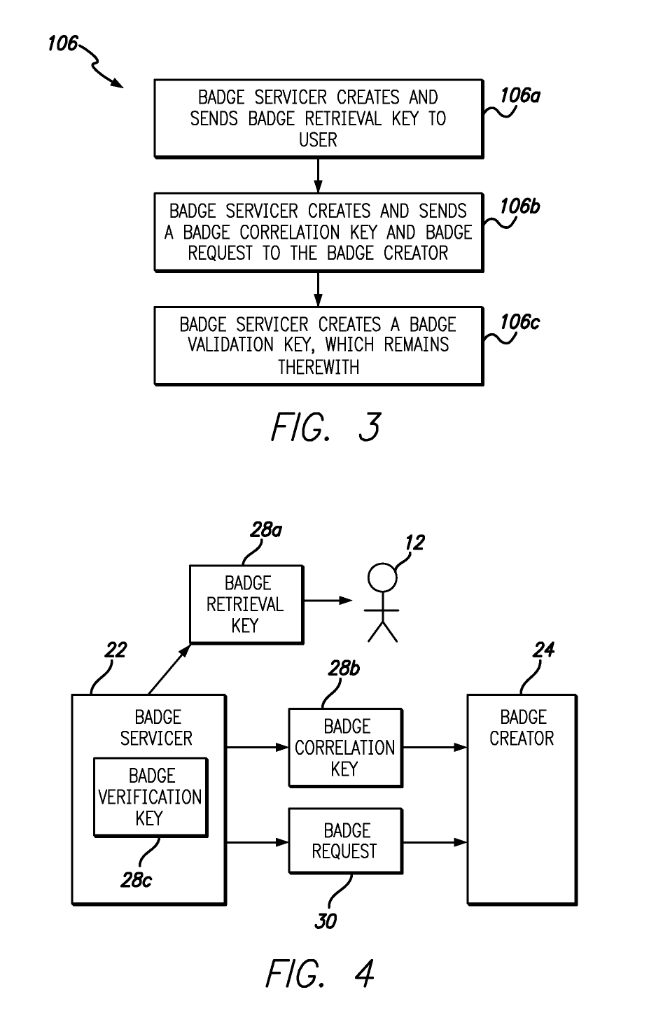

Furthermore, FIG. 2 illustrates one method for zero-knowledge attestation validation (100) in accordance with the embodiments disclosed herein. The steps and related apparatuses of this method (100) are more specifically shown and described below with respect to FIGS. 3-14. The first step (102) is for the user 12 to make an initial unverified statement or claim in the primary system 16 using the primary system identity 14. Alternately, the user 12 may indicate the intention to make an initial unverified statement or in the primary system 16. In this case, the user 12 may endeavor to seek out and/or obtain attestation before actually making the statement or claim. Importantly, the primary system 16 has no way of ascertaining if the statement or claim made by the user 12 is true. The statement or claim may be related to employment status or history, financial well-being (or lack thereof), relationship status with another person (e.g., friends, spouse, etc.), or any other statement or claim that the primary system 16 cannot directly verify. For example, if the primary system 16 is a social media network, the user 12 may claim thereon to be employed by Corporation X. The social media network does not have the information stored therein to verify whether the user 12 is, in fact, a Corporation X employee. The system 10 disclosed herein advantageously allows the primary system 16 to verify this statement with the authority system 20 without exchanging private user information between the two entities.

The next step (104) is for the primary system 16 to request the badge 26 from the badge servicer 22. Preferably, the primary system 16 may also prompt the user 12 to request the badge 26 from the badge servicer 22 if the user 12 posts a statement or claim that needs verification. Alternately, the user 12 may manually request the badge 26 from the badge servicer 22. The manual request may be before or after indicating the intention to make a statement or claim that needs verification. Requiring the user 12 to initiate the attestation process enhances the security of the system 10 because unverified and ultimately verified statements can only originate with the user 12 having the primary system identity 14. In other words, third parties are unable to make unverified statements—statements that may later need verification in accordance with the embodiments disclosed herein—because of account restrictions. Although, preferably, the primary system 16 automatically requests the badge 26 from the badge servicer 22 once the user 12 makes an unverified statement or claim therein. The request may include any information necessary to identify the primary and authority systems 16, 20 and the statement that needs verification.

The next step (106) is for the badge servicer 22 to create a set of validation keys 28, as more specifically shown in FIGS. 3 and 4. For example, the badge servicer 22 creates and sends a badge retrieval key 28a to the user 12 as part of step (106a) shown in FIG. 3. The badge servicer 22 then creates and sends a badge correlation key 28b and a badge request 30 to the badge creator 24 as part of step (106b). Importantly, the badge retrieval key 28a and the badge correlation key 28b do not include any information related to the primary or authority system identities 14, 18. The badge request 30 contains the information sought to be verified by the authority system 20 (e.g., whether the user 12 is an employee of Corporation X). Next, the badge servicer 22 creates a badge verification key 28c, which remains with the badge servicer 22 during the badge request process. The badge verification key 28c contains information related to the primary system identity 14 (e.g., username) so the badge 26 can be later matched with the primary system identity 14 of the user 12. Of course, steps (106a), (106b), and (106c) may be performed in any order. The set of validation keys 28 may be of any format or construction known in the art, as long as the badge retrieval key 28a, the badge correlation key 28b, and the badge verification key 28c can be reliably matched with one another. Preferably, the keys 28a and 28b are constructed in a manner that makes it computationally impractical to generate one from the other, thereby increasing the security of system 10. Alternatively, each of the keys 28a, 28b, and 28c may be represented by the same code, token, or other item that can be trivially matched if security is less of an issue.

FIG. 5 illustrates distribution and storage of the set of validation keys 28 throughout the system 10 at the completion of step (106). As shown, the badge creator 24 retains the badge correlation key 28b and the badge request 30, the user 12 holds the badge retrieval key 28a, and the badge servicer 22 stores the badge verification key 28c. Importantly, the primary system 16 does not know the authority system identity 18 of the user 12, and the authority system 20 does not know the primary system identity 14 of the user 12. This holds true even in the event that one or more of the key holders are partially or completely compromised.

The next step (108) in the flowchart of FIG. 2 is for the user 12 to present the badge retrieval key 28a to the badge creator 24, as schematically illustrated in FIG. 6. The user 12 preferably includes information related to the authority system identity 18 (e.g., username) with the badge retrieval key 28a when presenting the same to the badge creator 24. This enables the badge creator 24 to identify the authority system 20 and the authority system identity 18. The user 12 may present the badge retrieval key 28a and related identity information via email, webpage, online portal, via other known mediums over an electronic communication network, or any other method of presenting or conveying information known in the art. Step (108) is preferably performed at any time after the set of validation keys 28 is created and distributed in accordance with steps (106) and (106a)-(106c). In one embodiment, the set of validation keys 28 may expire if the user 12 does not present the badge retrieval key 28a to the badge creator 24 before expiration of some predetermined duration. Key expiration provides an extra level of security to the system 10 by preventing old sets of the validation keys 28 from providing information to the primary system 16 long after the initial request.

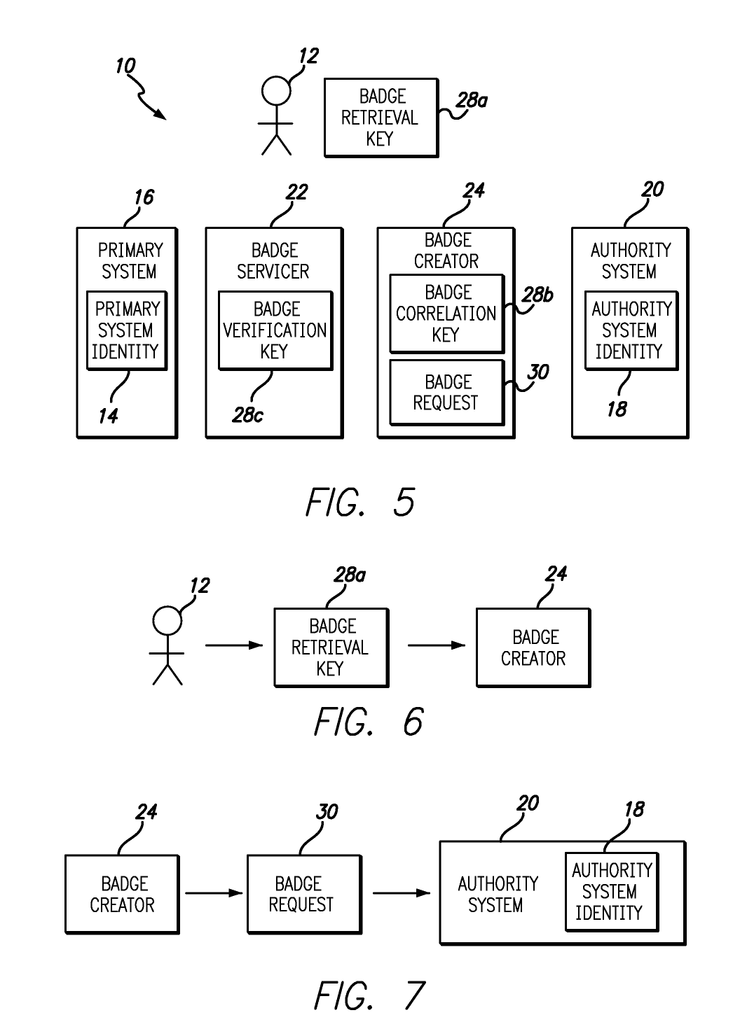

The next step (110) is for the badge creator 24 to compare the badge retrieval key 28a to all badge correlation keys stored therein to determine if there is a match. If there is no match, the badge creator 24 responds to the user 12 indicating that the corresponding badge correlation key 28b cannot be located and the validation process may terminate or the user 12 may be given another opportunity to provide a matching badge retrieval key 28a. If there is a match, the badge creator 24 adds the authority system identity 18 provided by the user 12 with the badge retrieval key 28a to the badge request 30. Then, the badge creator 24 sends the badge request 30 to the authority system 20 as part of step (112) in FIG. 7 to authenticate the statement or claim.

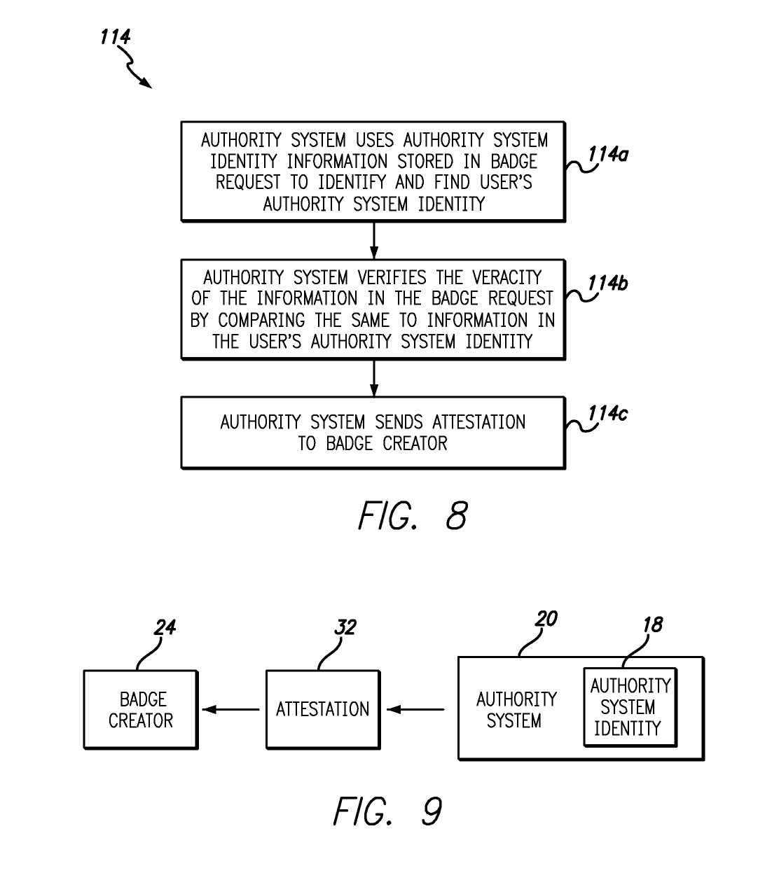

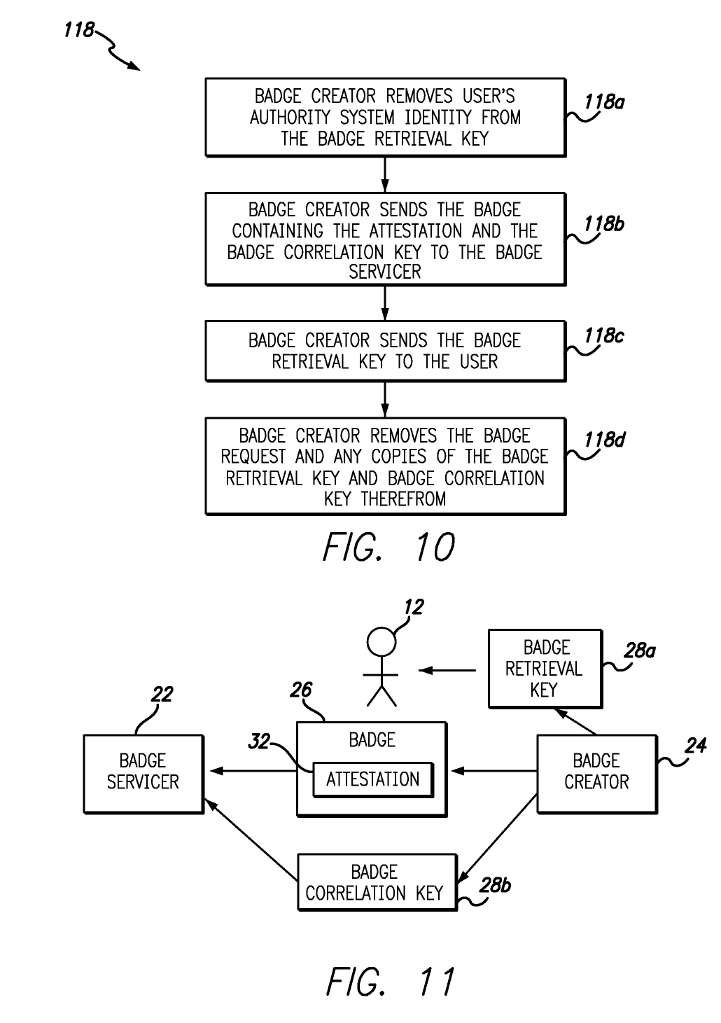

The next step (114) is for the authority system 20 to verify the veracity of (i.e., attest to) the information in the badge request 30, as shown more specifically in FIG. 8. In step (114a), the authority system 20 uses the authority system identity 18 stored in the badge request 30 (e.g., username) to access the authority system identity 18 of the user 12. The authority system 20 uses information associated with the authority system identity 18 (e.g., user account/name, email address, social security number, etc.) to identify the authority system identity 18 (e.g., profile) of the user 12 from all other authority system identities stored in association with the authority system 20. In step (114b), the authority system 20 verifies the veracity of the information in the badge request 30 by comparing the statement or claim to information stored in the authority system identity 18. For example, an authority system 20 that is a banking system could verify the current balance, last deposit, payment history, etc. of the user 12. In other examples, a shopping website could verify that the user 12 purchased a particular product; a credit card company could verify age, credit rating, or mailing address; a smartphone could verify location information by way of WiFi, cell tower or GPS location technologies; a social networking website could verify “friend” or “family” relationships; or a corporate human resources database could verify employment status, position, salary, management level, performance review scores, etc. This list is certainly non-exhaustive and the validation steps disclosed herein are applicable to virtually any type of information. The next step (114c) shown more specifically in FIG. 9 is for the authority system 20 to send an attestation 32 indicating the veracity of the information contained in the badge request 30 (or lack thereof) to the badge creator 24. The attestation 32 indicates whether the statements or claims made by the user 12 on the primary system 16 are true.

In step (116) shown in FIG. 2, the badge creator 24 next creates the badge 26 containing the attestation 32 from the authority system 20. For example, if the authority system 20 is the Corporation X employee directory, the badge 26 may contain the attestation 32 that the user 12 is or is not employed by Corporation X. Importantly, the badge 26 contains no information relating to the primary system identity 14 or the authority system identity 18.

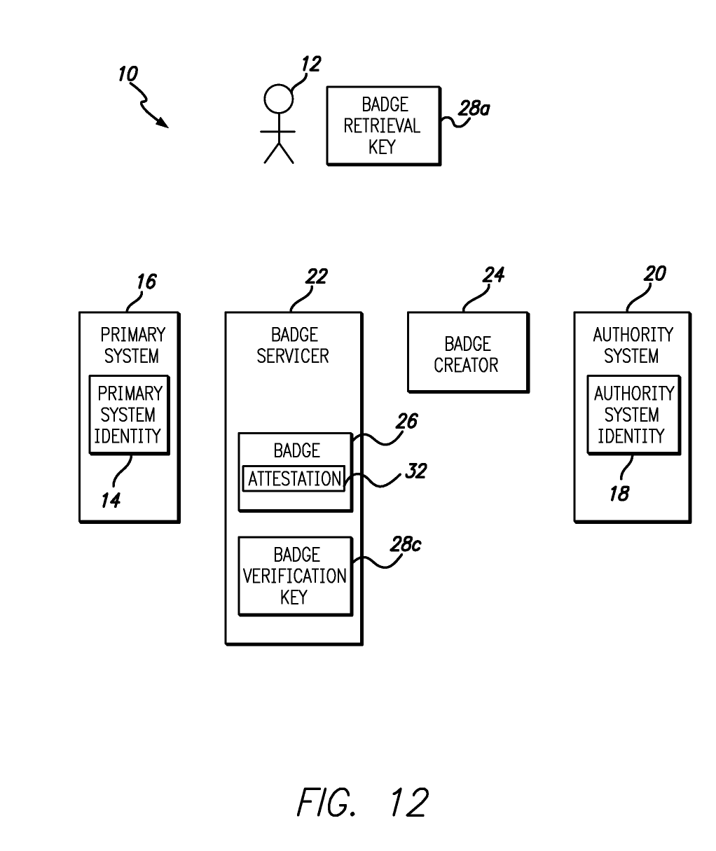

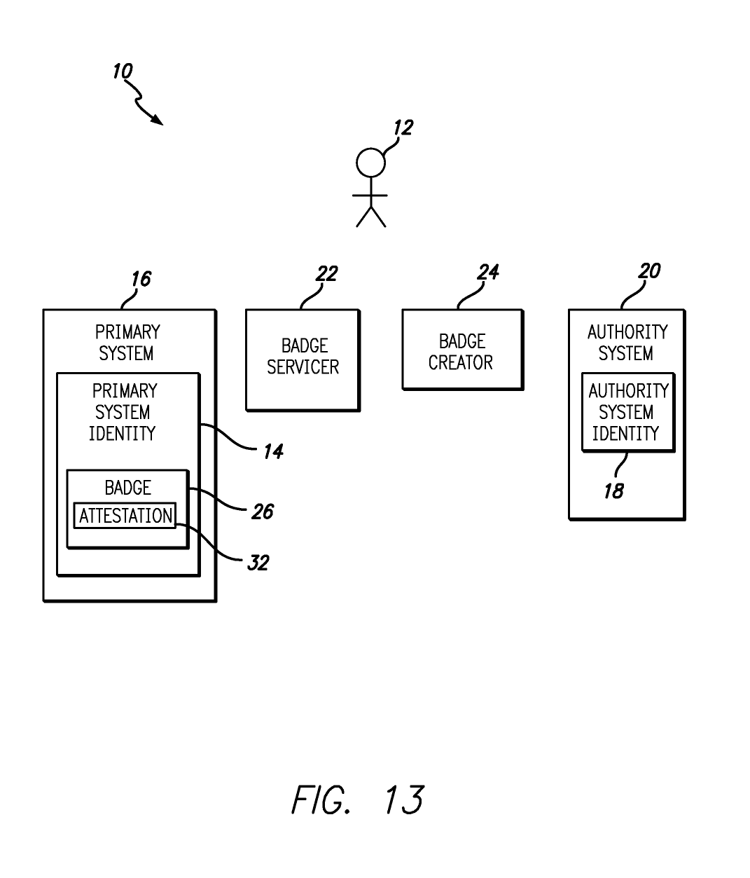

The next step (118) is for the badge creator 24 to send the badge 26 with the attestation 32 to the badge servicer 22. Step (118) is more specifically illustrated in the flowchart of FIG. 10 and the schematic of FIG. 11. In this regard, as part of step (118a) shown in FIG. 10, the badge creator 24 preferably removes the authority system identity 18 and/or other information that may identify the authority system 20 from the badge retrieval key 28a (if present). The badge creator 24 then sends the badge 26 containing the attestation 32 and the badge correlation key 28b to the badge servicer 22 as part of step (118b). In step (118c), the badge creator 24 sends the badge retrieval key 28a to the user 12. Next, in step (118d), the badge creator 24 removes the badge request 30 and any copies of the badge retrieval key 28a and/or the badge correlation key 28b. Importantly, steps (118a), (118b), and (118c) may be performed in any particular order.

Next, in step (120), the badge servicer 22 matches the badge correlation key 28b to the badge verification key 28c and stores the badge verification key 28c with the badge 26. Then, the badge servicer 22 deletes the badge correlation key 28b. At this point, FIG. 12 illustrates the preferred arrangement of the badge 26 and the set of validation keys 28 throughout the system 10 upon completion of step (120). Here, the user 12 holds the badge retrieval key 28a (previously stripped of any information by the badge creator 22 that could identify the authority system identity 18 or the authority system 20) and the badge servicer 22 holds the badge 26 and the badge verification key 28c. Importantly, at this point, the badge correlation key 28b and the badge request 30 have been completely removed from the system 10 and the badge creator 24 and the authority system 20 are no longer in possession of any information related to the attestation process (100).

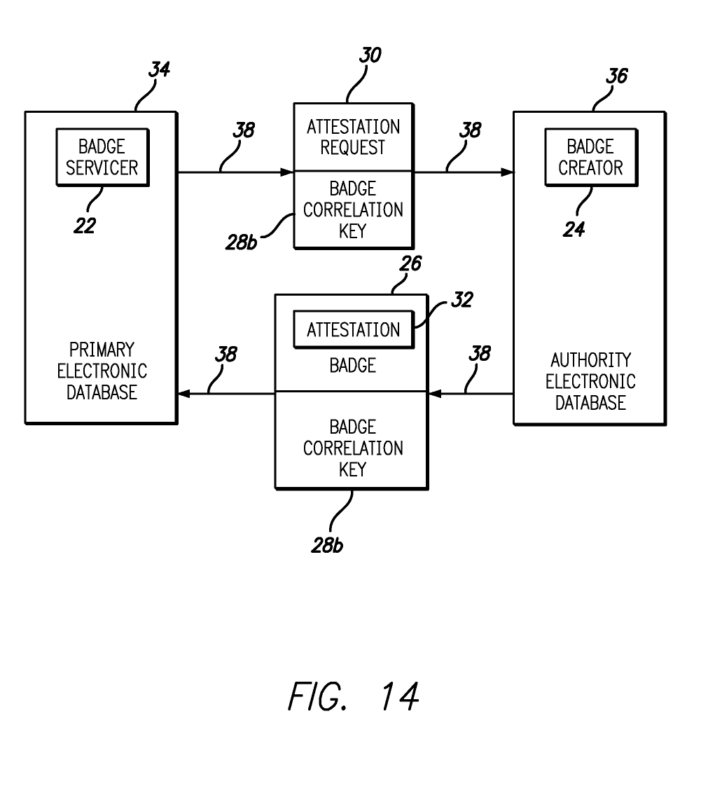

Next, in step (122), the badge servicer 22 searches for the badge verification key 28c that corresponds to the badge correlation key 28b presented with the badge 26. If there is no match, the badge servicer 22 may return a message indicating that the badge verification key 28c could not be found. Alternatively, if the badge servicer 22 finds the corresponding badge verification key 28c, the badge servicer 22 adds the badge 26 and the accompanying attestation 32 to the primary system identity 14 for the user 12. Accordingly, the original statement or claim now has an accompanying attestation 32 associated with the primary system identity 14 of the user 12 in the primary system 16. Of course, once this step is performed, any remaining keys from the set of validation keys 28 are deleted to ensure security and privacy. In this respect, FIG. 13 illustrates the system 10 after step (122). That is, the badge 26 and the attestation 32 are incorporated into the primary system identity 14 of the user 12 and all of the set of validation keys 28 have been deleted from the system 10.

As illustrated above, the primary system 16 and the authority system 20 never know the identity of the other. As such, the user 12 may make statements or claims in the primary system 16, the veracity of which can be verified by the authority system 20, without revealing the authority system identity 18 to the primary system 16 and without revealing the primary system identity 14 to the authority system 20. In the example used above, the user 12 may claim to be employed by Corporation X on a social media network and the Corporation X employee directory could attest to the veracity of this claim without the social media network learning the identity of the user 12 at Corporation X (e.g., the user's Corporation X email address) and without Corporation X learning the identity of the user 12 in the social media network (e.g., the user's social media network username). Importantly, the system 10 does not necessarily need to protect the primary and authority system identities 14, 18 via encryption or any other scheme or method that could be subject to manipulation or breech. Rather, the primary system 16 never has access to the authority system identity 18 and the authority system 20 never has access to the primary system identity 14. The only key in the system 10 that ever contains any information about the user's primary system identity 14 is the badge verification key 28c. The authority system 20 never has access to the badge verification key 28c and, thus, the information contained therein. Likewise, the badge retrieval key 28a is the only key that ever contains information related to the authority system identity 18 or the authority system 20. Since this information is added after the badge retrieval key 28a leaves the badge servicer 22 and is removed after the attestation, the primary system 16 never has access to the authority system identity 18 or the authority system 20.

Importantly, the system 10 transforms an unattested or unverified statement or claim made in the primary system 16 into an attested or verified statement or claim by way of the processes disclosed herein. As such, the system 10 is advantageous over known systems as attested statements and claims are vastly different and certainly preferred over unattested statements and claims. As mentioned above, third parties do not know whether unattested statements are true or false. Thus, unattested statements may provide little or no value as a result of the uncertainty of the validity of the statement or claim. That is, third parties do not know whether to rely on the information in the unattested statement or claim. Conversely, however, attested statements are valuable because the information in the statement or claim has been verified as true (or false) by an authority system. So, unlike unattested statements or claims, the value in an attested statement or claim is the fact that the information has been verified as true (or false). Third parties are not left to guess or decipher whether the statement or claim is true or false. In this respect, the system and methods disclosed herein securely transform such an unattested statement or claim into a valuable attested statement or claim that users can trust without cross-disclosing the identity of the user between the primary and the authority systems.

Specifically, the system 10 facilitates verification of a claim or statement without providing access to the underlying data used for verification. Accordingly, the system 10 can be used to validate claims where verifying data is private or sensitive. For example, chronic disease patient support network users might want to identify themselves as patients, doctors, survivors, family members, or caregivers. The information needed to attest to such a claim may be located in the Hospital Information System (“HIS”), thereby being subject to laws such as the Health Insurance Portability and Accountability Act (“HIPPAA”) that prevent sharing thereof. In this respect, the system 10 could allow the HIS to attest to the veracity of a patient support network user's claim without revealing personally identifiable information, thereby remaining compliant with HIPAA. Moreover, a group protesting a totalitarian regime might establish an online communication network in an attempt to open discussions of government policies and elicit possible responses. As such, the network users may be subject to extreme repercussions including torture or death if the true identities are revealed. Since users of such a network may want to mask their identities, the network may want users to establish certain facts such as whether they are students, whether they live in the country, or whether they are a member of the opposition party. As such, the systems and the methods disclosed herein allow the communication network (i.e., primary system 16) to access the underlying data necessary to verify these claims (i.e., the authority system 20) without risking disclosure of personally identifiable information. Thus, even if the regime compels the primary system 16 to turn over all user records, the regime will still be unable to uncover the identities of the users that belong to the network since the network never had this information.

Although FIGS. 1-13 illustrate one embodiment of the system 10 that includes a single authority system 20, the systems and methods disclosed herein permit the user 12 to import badges 26 with accompanying attestations 32 from a plurality of different authority systems.

FIG. 14 illustrates a preferred embodiment for storing and communicating information with respect to the system 10, as described above. Preferably, information in the primary system 16 is stored in a primary electronic database 34 and information in the authority system 20 is stored in an authority electronic database 36. The primary and authority electronic databases 34, 36 may be any type of information storage database known in the art, such as a hard drive, solid state drive, server, or other storage medium known in the art. The databases 34, 36 are preferably separately operated and managed. In view of the above examples, the database 34 may be owned and operated by a social network website while the database 36 may be owned and operated by Company X. Although, of course, the databases 34, 36 may be owned and operated by a single entity and as part of one system (i.e., the databases 34, 36 may be part of a subsystem of a larger parent or umbrella system), e.g., as described above with respect to a human resources department having multiple access levels. In the embodiment shown in FIG. 14, the system 10 also preferably includes a communications network 38 (e.g., the Internet, a LAN, WAN, etc.) to facilitate the exchange and communication of information therein. In one embodiment, the badge servicer 22 and the badge creator 24 may be integrated into the primary electronic database 34 and/or the authority electronic database 36, respectively. Of course, the badge servicer 22 and/or the badge creator 24 may be separate from the primary electronic database 34 and/or the authority electronic database 36. As shown in FIG. 14, the databases 34, 36 communicate with one another via the communications network 38 as part of facilitating the zero-knowledge attestation validation process shown and described herein. Specifically, the primary electronic database 34 may send the badge request 30 and the badge correlation key 28b over the communications network 38 (e.g., the Internet) to the authority electronic database 36. Once the authority electronic database 36 verifies the veracity of the information in the badge request 30, the authority electronic database 36 sends the badge 26 containing the attestation 32 and the badge correlation key 28b to the primary electronic database 34 via the same or a different communications network 38.

In one example, the primary electronic database 34 may be associated with a social media network and used as a server to store and retrieve text, pictures, videos, and other social media content. The authority electronic database 36 may be an employee directory of Corporation X and may be a server that stores and retrieves Company X employee information. The social media network and the employee directory may both connect to the Internet over the aforementioned data communication network 38. As such, the data communication network 38 allows the social media network and Corporation X to provide the attestations 32 therebetween in accordance with method (100). In this respect, system 10 permits electronic databases to exchange attestations with other electronic databases over a common, shared or separate data communication network. Of course, the data communication network 38 does not necessarily need to be connected to both of the databases 34, 36 simultaneously. For example, in one embodiment, the set of validation keys 28 may be transmitted by exchanging information with information stored on a USB drive that is otherwise disconnected from the data communication network 38 from time-to-time.

Importantly, nothing limits the systems or methods disclosed herein to the domain of electronic or online communication. As such, the primary system 16 and the authority system 20 may be any systems, electronic or otherwise, where the user 12 is represented by the primary system identity 14 and the authority system identity 18, respectively, including, inter alia, a housing complex, sports stadium, experimental drug trial, banking system, board game, etc. In this respect, the systems and methods disclosed herein are applicable to a wide range of operating environments.

Although several embodiments have been described in detail for purposes of illustration, various modifications may be made without departing from the scope and spirit of the invention. Accordingly, the invention is not to be limited, except as by the appended claims.

What is claimed is:

1. A method for zero-knowledge attestation validation, comprising the steps of:
receiving a statement from a primary account in a primary electronic database over a communication network for validation with an authority account in an authority electronic database;
creating a set of keys permitting validation of said statement without said primary electronic database identifying said authority account and without said authority electronic database identifying said primary account;
associating a first key with said statement;
correlating said associated first key and statement with a second key identifying said authority account;
validating the veracity of said statement as an attestation with said authority account over said communication network;
relating said first key with said attestation;
linking said related first key and attestation with a third key identifying said primary account; and
transmitting said attestation to said primary electronic database over said communication network for storage in said primary account with said statement.

2. The method of claim 1, wherein said correlating step includes the step of matching said first key with said second key and said linking step includes the step of matching said first key with said third key.

3. The method of claim 1, including the step of deleting said second key after said relating step, deleting said first key after said linking step, and deleting said third key after said transmitting step.

4. The method of claim 1, wherein said associating step includes associating said first key with said statement outside said primary electronic database and said relating step includes relating said first key with said attestation outside said authority electronic database.

5. The method of claim 1, wherein said statement comprises an unverified statement.

6. The method of claim 5, wherein said transmitting step includes the step of transforming said unverified statement into a verified statement with said attestation.

7. The method of claim 1, wherein said associating step includes the step of forming a badge request from said associated first key and statement.

8. The method of claim 7, including the step of sending said badge request over said communication network to a badge creator.

9. The method of claim 8, including the step of conveying said attestation over said communication network to said badge creator.

10. The method of claim 1, wherein said relating step includes the step of forming a badge from said related first key and attestation.

11. The method of claim 10, including the step of sending said badge over said communication network to a badge servicer.

12. The method of claim 11, including the steps of conveying said second key to a third party for identifying said authority account and storing said third key with said badge servicer.

13. The method of claim 1, wherein said set of keys comprise encrypted keys.

14. The method of claim 1, wherein said statement comprises multiple statements and said set of keys comprises multiple sets of keys, wherein each set of keys corresponds to a respective statement.

15. The method of claim 1, wherein said attestation includes the veracity of said statement.

16. The method of claim 1, wherein said primary electronic database comprises a social network and said authority electronic database comprises a corporate network.

17. The method of claim 1, wherein said first key comprises a correlation key, said second key comprises a retrieval key and said third key comprises a verification key.

18. A method for zero-knowledge attestation validation, comprising the steps of:
receiving a statement from a primary account in a primary electronic database over a communication network for validation with an authority account in an authority electronic database;
creating a set of keys permitting validation of said statement without said primary electronic database accessing said authority account and without said authority electronic database accessing said primary account;
issuing a badge request including a first key and said statement;
correlating said badge request with a second key identifying said authority account, wherein said correlating step includes the step of matching said first key with said second key;
validating the veracity of said statement as an attestation with said authority account over said communication network;
forming a badge including said first key and said attestation;
linking said badge with a third key identifying said primary account, wherein said linking step includes matching said first key with said third key;
transmitting said attestation to said primary electronic database over said communication network for storage in said primary account with said statement; and
deleting said second key after said forming step, deleting said first key after said linking step, and deleting said third key after said transmitting step.

19. The method of claim 18, wherein said issuing step includes issuing said badge request outside said primary electronic database and said forming step includes forming said badge outside said authority electronic database.

20. The method of claim 18, wherein said transmitting step includes the step of transforming said statement comprising an unverified statement into a verified statement.

21. The method of claim 18, including the step of sending said badge request to a badge creator and said badge to a badge servicer over said communication network.

22. The method of claim 21, including the steps of:
conveying said attestation over said communication network to said badge creator;
communicating said second key to a third party for identifying said authority account; and
storing said third key with said badge servicer until said transmitting step.

23. The method of claim 18, wherein said statement comprises multiple statements and said set of keys comprises multiple sets of keys, wherein each set of keys corresponds to a respective statement and wherein said primary electronic database comprises a social network and said authority electronic database comprises a corporate network.

24. A method for zero knowledge attestation validation, comprising the steps of:
producing at least three matchable keys;
conveying a first key to a third party having information on an authority account and conveying a second key associated with an unverified statement to a badge creator;
retaining a third key with a badge servicer;
matching said first key having said authority account with said second key having said unverified statement in said badge creator;
creating an attestation based on the veracity of said unverified statement cross-referenced with said authority account;
correlating said second key having said attestation with said third key in said badge servicer;
storing said attestation in association with a primary account associated with said unverified statement; and
transforming said unverified statement into a verified statement based on comparing said attestation with said unverified statement without said authority account identifying said primary account and without said primary account identifying said authority account.

25. The method of claim 24, wherein said correlating step includes the step of forming a badge comprising said second key and said attestation.

26. The method of claim 24, including the step of deleting said first key after said creating step.

27. The method of claim 24, wherein said matching step includes the step of creating a badge request comprising said second key and said unverified statement.

28. The method of claim 27, including the step of sending said badge request to said authority account.

29. The method of claim 24, including the step of validating the veracity of said unverified statement with said authority account;

30. The method of claim 24, wherein said verified statement comprises a true statement.

31. A method for zero-knowledge attestation validation, comprising the steps of:
communicating with an authority account in a first electronic database over a communication network to attest to the veracity of at least one unattested statement made in a second electronic database associated with a primary account;
creating at least one badge attesting to the veracity of said at least one unattested statement;
conveying said at least one badge to said second electronic database over said communication network;
storing said at least one badge in association with said primary account in said second electronic database; and
transforming said at least one unattested statement into at least one attested statement without said authority account in said first electronic database identifying said primary account in said second electronic database and without said primary account in said second electronic database identifying said authority account in said first electronic database.

32. The method of claim 31, wherein the communicating step includes the step of requesting at least one badge from a badge creator.

33. The method of claim 32, wherein said badge request includes the step of forming a badge retrieval key, a badge correlation key, and a badge verification key.

34. The method of claim 33, including the step of conveying said badge retrieval key to a third party and said badge correlation key to said badge creator, and storing said badge verification key with a badge servicer.

35. The method of claim 34, including the steps of presenting said badge retrieval key to said badge creator and matching said badge retrieval key with said badge correlation key.

36. The method of claim 34, including the steps of presenting said at least one badge to said badge servicer and matching said badge correlation key with said badge verification key.
